(19) United States
(12) Patent Application Publication
(10) Pub. No.: US 2005/0275406 A1
(43) Pub. Date: Dec. 15, 2005

(54) Apparatus and method of dynamic usage profile acquisition and utilization in a wireless mobile device

(76) Inventors: Atul N. Hatalkar, Chandler, AZ (US); Robert C. Knauerhase, Portland, OR (US); Brian V. Belmont, West Linn, OR (US); Gregory H. Kisor, Portland, OR (US); Lenka M. Jelinek, Portland, OR (US); Muthu K. Kumar, Hillsboro, OR (US)

Correspondence Address: INTEL CORPORATION, P.O. BOX 5326, SANTA CLARA, CA, 95056-5326, US

(21) Appl. No.: 10/868,703

(22) Filed: Jun. 15, 2004

(51) Int. Cl. G01N 27/42

(52) U.S. Cl. 324/425

(57) ABSTRACT

An apparatus comprising a usage analysis engine may be capable of receiving data on the environment of the apparatus, the data used to create a profile. The usage analysis engine may be further capable of correlating a present profile with previous profiles. The apparatus may take some action or prohibits some action based on the correlation of the present profile with the previous profiles provided by the usage analysis engine and may take no action based on lack of correlation of the present profile with the previous profiles provided by the usage analysis engine.

### BACKGROUND

In today's wireless environment numerous devices are present and may be connected wirelessly. The numbers and variety of devices with varying functionality provides a dynamic usage environment creating challenges for improved interconnectivity.

Thus, there is a continuing need for better ways for wireless devices in the wireless environment to communicate and provide functionality seamlessly and assist the user of the wireless device in ease of operation.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an illustration of one possible wireless environment that depicts the dynamic usage profile acquisition and utilization in a wireless mobile device of an embodiment of the present invention;

FIG. 2 is a flowchart showing a method of operation of one embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause an effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like).

Types of cellular radiotelephone communication systems intended to be within the scope of the present invention include, although not limited to, Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wide-band CDMA (WCDMA), CDMA-2000, and the like.

One embodiment of the present invention may be a wireless mobile device that dynamically compiles a profile based on its usage in the context of the state of the external environment. The information gathered by this device may be multi-dimensional and may provide for the dynamic compilation of multi-dimensional profiles and dynamic pattern-matching with the changing state of the environment. Further, it may provide pro-active responses that may be based on these profiles. The device, upon receiving a trigger, may record information consisting of its own operational state (such as applications in use, etc.) and the state of external environment (such as time, location, proximity to other devices, descriptions of other devices and their states, etc.). The information may be used to build a profile depicting the relationships among the recorded data. Each time a new snapshot of environmental state is recorded, the profile may be dynamically updated. More than one profile may be maintained on a device.

In normal usage, the device may continually monitor the external environment and attempt to correlate it with the saved profiles. When a match is found, with a predetermined certainty, between the current state of the environment and a previously stored profile, the device may perform an action or a series of actions that would be most relevant given the environmental conditions. For example, a device may automatically launches an ‘e-wallet’ application in the vicinity of a particular bank since the device has ‘learned’ that the user may usually do it at that location. The device receives a confirmation for its predicted action when the user indeed makes use of the e-wallet application that was automatically launched.

To build the profile, generally, the user of the device may have full control on when and what kind of profile the device builds. If so enabled, a device may trigger a profile update whenever any application may be launched. Other possible trigger events may be change in time, proximity of an advertised service, proximity of another device, and many more. This list is but a fraction of the possible trigger events and the aforementioned enumeration is merely an illustrative list and should not be considered to limit the present invention. Again, in all cases, the user may choose which events are valid triggers. Some or all non-trigger events, even when detected, may be ignored by the device. Also, the user may choose to relinquish control of the trigger event. In that case, the device may record environmental information to the extent permitted by its resources (computing power, storage capability, etc.). Further, some other intermediate state, between full control and no control may be enabled depending on the needs and desire of the user.

In one embodiment of the present invention, the device may sense the state of its environment. This includes ability to communicate seamlessly and automatically with proximate devices and networks. The communication may occur wirelessly according to a wide variety of wireless communication methodologies know to those ordinary skill in the art and some of which are mentioned above, such as, by way of example only and not limitation, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like). Also, as mentioned above, wireless communication such as cellular radiotelephone communication systems are intended to be within the scope of the present invention.

The device also may determine its current location. This may be accomplished by using the Global Positioning System (GPS) or by communicating with other location aware devices or by communicating with other well-known fixed wireless services. Although it should be understood that the scope and application of the present invention is in no way limited to these examples. In another embodiment of the present invention there may be a ‘usage analysis engine’ that aggregates the snapshots of an environment to create or update the profile(s). The same engine may also predict actions when it ‘recognizes’ a pre-stored combination of environmental state variables. For example, and not meant to limit in any way the scope of the present invention, the engine may put the device into the same state that the user had put it in earlier (e.g. buzzer off inside Movie Theater) or open an application (e.g. e-wallet example above) that was open the last time the environmental variables matched. The engine may also note user's subsequent action(s) indicating whether the predicted action was desirable or not. This helps ‘train’ or fine tune the profile to develop responses that are helpful to user. The analysis engines may use a processor, such one that based on Intel® XScale architecture, to utilize heuristics and pattern matching algorithms to accomplish the aforementioned. However, it is understood that this analysis engine is but one type of analysis engine and one type of processor and it is anticipated that a wide variety of methodologies to analyze the present environment vis-a-vis previous environments may be employed and is anticipated by the present invention. Further, the present invention may be any combination or hardware and software.

The combination of external and internal state information may give the device a broader range of responses to a broader range of conditions, thus potentially increasing its perceived intelligence and value to the user.

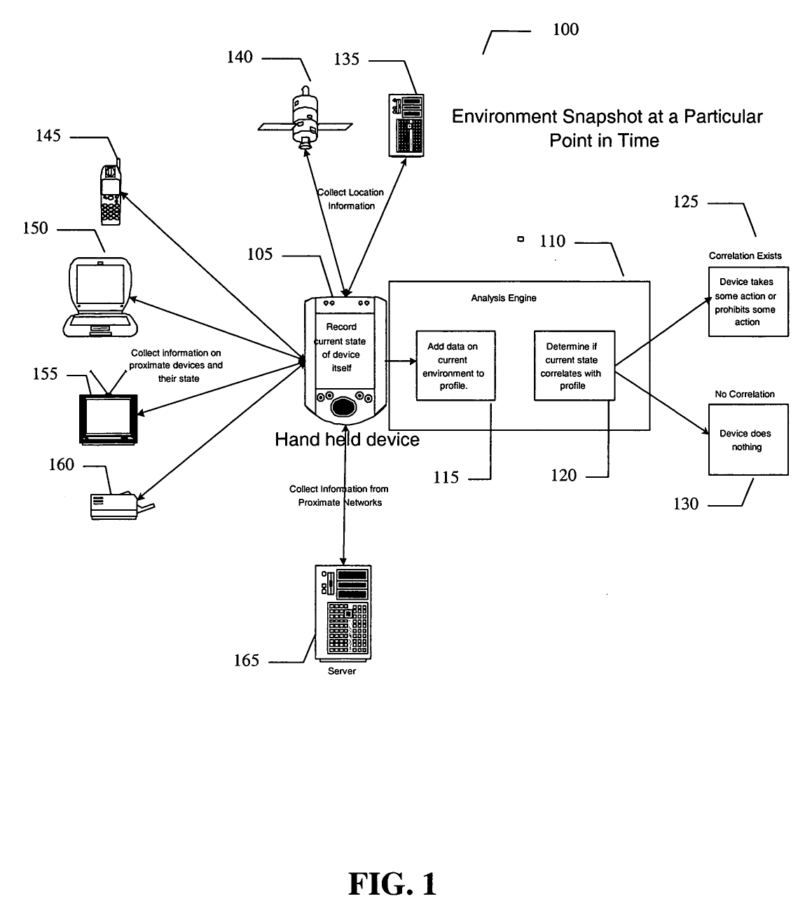

Turning to FIG. 1, an embodiment 100 for dynamic usage profile acquisition and utilization in a wireless mobile device in accordance with the present invention is described. Embodiment 100 may comprise a portable communication device 105 such as a mobile communication device (e.g., Personal Digital Assistant (PDA) or cell phone), a two-way radio communication system, a one-way pager, a two-way pager, a personal communication system (PCS), a portable computer, or the like. Although, it should be understood that the scope and application of the present invention is in no way limited to these examples.

Portable communication device 105 may include a processor (not shown) that drives an analysis engine 110. The processor may be one of a variety of integrated circuits such as, for example, a microprocessor, a central processing unit (CPU), a digital signal processor, a microcontroller, a reduced instruction set computer (RISC), a complex instruction set computer (CISC), or the like, although the scope of the present invention is not limited by the particular design or functionality performed by processor.

Portable communication device 105 may also optionally include other components such as a display 107 and memory (e.g. RAM, non-volatile memory, or any of the other memory types described above). Memory may be used to store instructions to be executed by the integrated circuit and display 107 may present the results of the execution of those instructions to a user. Although it should be understood that the scope and application of the present invention is not limited to the above configuration of components.

An interface 109 may be used to provide communication or information between portable communication device 105 and a user. Alternatively or in addition, portable communication device may include other components such as input/output devices, audio outputs, etc. However it should be understood that the scope of the present invention is not limited so as to require any particular combination of components shown in FIG. 1.

In order to facilitate wireless communication, portable communication device 105 may include a base band processor (not shown), such as one of the types described above and a transceiver (not shown) to provide access to other devices, service, networks, etc that may be used to allow portable communication device 50 to communicate with other networks through either a wired or wireless link. The transceiver may use antennas to wirelessly communicate. As stated above, although the scope of the present invention is not limited in this respect, communication transceiver 85 may employ a variety of wireless communication protocols such as cellular (e.g. Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wide-band CDMA (WCDMA), CDMA-2000, and the like). In addition, portable communication device 50 may also include multiple transceivers that use different communication protocols.

In addition, the transceiver may use other protocols such as wireless local area network (WLAN), wide area network (WAN), or local area network (LAN) protocols such as the Industrial Electrical and Electronics Engineers (IEEE) 802.11, 802.16 and 802.18 standards, Bluetooth™, infrared, etc. (Bluetooth is a registered trademark of the Bluetooth Special Interest Group).

It should be understood that the scope of the present invention is not limited by the types of, the number of, or the frequency of the communication protocols that may be used by portable communication device 105. Furthermore, alternative embodiments may have more than two communication modules and communication modules need not have separate antennae, and some or all may share a common antenna. It should also be understood that the communication subsystem may include other optional components such as, for example, a vocoder to encode voice data, etc.

Returning to analysis engine 110, as briefly described above, there is included therein the ability to acquire and add data 115 on the current state of the environment and store it for subsequent comparisons. Storage may be provided by the memory and comparisons may be provided by algorithms executed by the processor, both described above. If a correlation exists 125, the portable communication device 105 may take some action or prohibit some action. If no correlation exists 130, the portable communication device may undertake no additional activities.

To illustrate the type of environments and the participants of such environments, FIG. 1 illustrates a number devices with which portable device 105 may be proximate to and in communication with. It is understood, however, that this illustration is but a small fraction of possible environments with participants and devices with which portable device 105 may communicate with and be proximate to. The environment of FIG. 1 includes portable device 105 proximate to and possibly in communication with a server 165, a printer with wireless communication interface 160, a desk top personal computer 155, a notebook computer with wireless communication capabilities 150, a personal radio communication device 145. As mentioned above, to facilitate in the determination of the position and proximate nature of the portable communication device within the environment, portable device 105 may receive position information from a Global Positioning System (GPS).

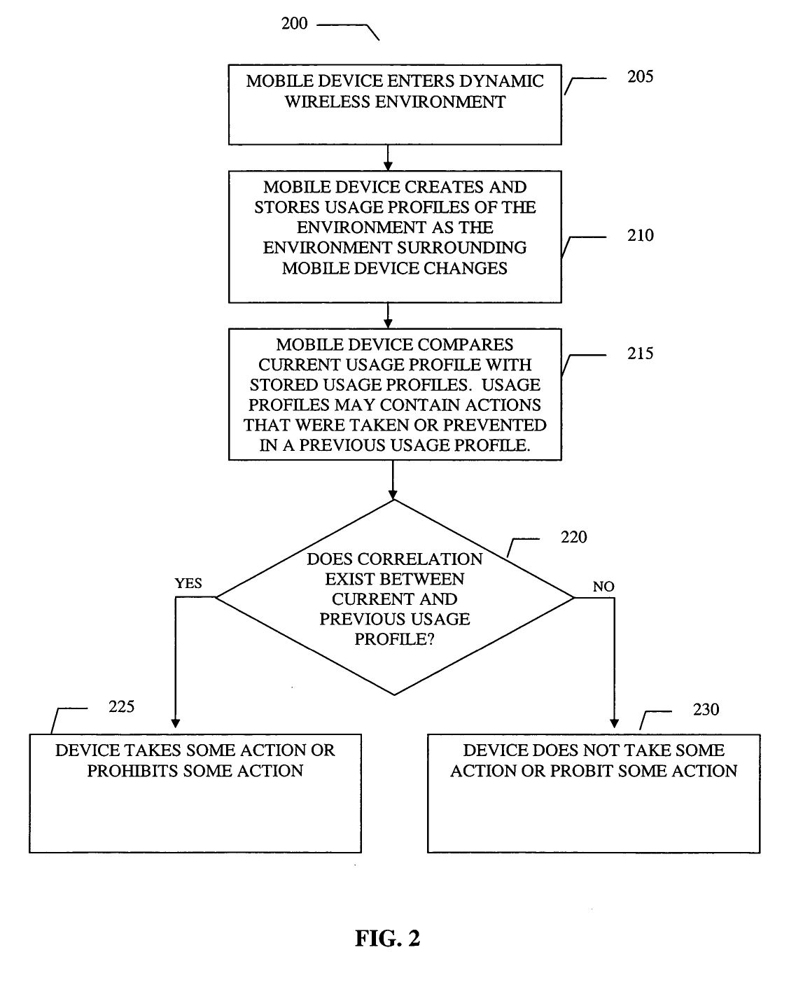

FIG. 2, shown generally as 200, is a flow chart of one method of operation of the present invention, wherein portable device enters a dynamic wireless environment at 205. Dynamic environment as used herein may include situations where the portable device's 105 proximate surroundings may vary in terms of, but not by way of limitation: proximity of other wireless devices it may communicate with; quality of the ether in which the RF signals emanate; power available to portable device 105 and devices with which portable device 105 communicates; applications added or subtracted to the portable device 105 or devices in which portable device 105 may be in communication with; position of portable device 105 or device with which portable device may be in communication with in a predetermined area or with respect to a predetermined person, place or thing; type of device the portable device may be 105; the type of wireless devices that the portable device 105 may be in communication with; input from the user of a portable device 105; or input from the user of a wireless device with which the portable device 105 may be in communication with. Again, the aforementioned enumeration is to exemplify one embodiment of the present invention and it is anticipated that a vast array of varying parameters in a given environment may make up a given profile.

After the portable device 105 enters the dynamic wireless environment at 205, the portable device may create and store at 210 usage profiles of the environment as the environment surrounding the portable device 105 changes. At 215 the portable device 105 may compare the current usage profile with stored usage profiles. The usage profiles may contain actions that were taken or prevented in a previous usage profile. At 220 a correlation may occur between current and previous usage profiles. If it may be determined that a correlation may exist between a current and previous usage profile, because the portable device may predict usage, the portable device 105 at 225 may take some action or prohibit some action. In one embodiment of the present invention, the step 225 of taking some action or preventing some action may be overridden by the user of the portable device 105 (even the overriding of the action may become part of the usage profile for use subsequently).

At 230, if it appears there may be no correlation between the current and previous profile, the portable device 105 may not take any action or prevent any action.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An apparatus comprising:
a usage analysis engine capable of receiving data on the environment of said apparatus, said data used to create a profile; and
said usage analysis engine further capable of correlating a present profile with previous profiles.

2. The apparatus of claim 1, wherein said apparatus is adapted to take some action or prohibits some action based on the correlation of said present profile with said previous profiles provided by said usage analysis engine.

3. The apparatus of claim 1, wherein said apparatus is adapted to take no action based on lack of correlation of said present profile with said previous profiles provided by said usage analysis engine.

4. The apparatus of claim 1, wherein said usage analysis engine is adapted to receive position information of said apparatus.

5. The apparatus of claim 4, wherein said position information is determined by a global positioning system.

6. The apparatus of claim 1, wherein said environment of said apparatus is comprised of at least one device in wireless communication with said apparatus.

7. The apparatus of claim 6, wherein said at least one device in wireless communication with said apparatus is a plurality of devices in communication with said apparatus.

8. The apparatus of claim 6, wherein said at least one device in wireless communication with said apparatus is at least one device in wireless communication with said apparatus selected from the group comprising:
personal digital assistant (PDA);
printer;
personal computer;
server;
mobile phone;
e-wallet;
wireless local area network access point;
wide area network access point; and
personal area network access point.

9. The apparatus of claim 1, wherein said apparatus is selected from the group consisting of:
personal digital assistant (PDA);
printer;
personal computer;
server;
mobile phone; or
e-wallet.

10. The apparatus of claim 1, further comprising a processor to correlate said present profiles with said previous profiles and memory for storing said profiles.

11. The apparatus of claim 1, wherein said usage analysis engine is further capable of receiving input from a user of said apparatus to direct the correlation algorithm so as to allow customization of when said apparatus takes some action or prohibits some action based on said correlation of said present profile with said previous profiles provided by said usage analysis engine.

12. An article comprising a storage medium having stored thereon instructions, that, when executed by a computing platform, results in the correlation of past and present environmental profiles, said past and present environmental profiles determined by a usage analysis engine associated with said article and capable of receiving data on the environment of said apparatus.

13. The article of claim 12, wherein said apparatus instructions, when executed, results it its taking some action or prohibiting some action based on said correlation of said present profile with said previous profiles provided by said usage analysis engine.

14. The article of claim 12, wherein said apparatus instructions, when executed, takes no action based on lack of correlation of said present profile with said previous profiles provided by said usage analysis engine.

15. The article of claim 12, wherein said apparatus instructions, when executed, enable said usage analysis engine to receive position information of said apparatus.

16. The article of claim 15, wherein said position information is determined by a global positioning system.

17. The article of claim 12, wherein said environment of said apparatus is comprised of at least one device in wireless communication with said apparatus.

18. The article of claim 17, wherein said at least one device in wireless communication with said apparatus is a plurality of devices in communication with said apparatus.

19. A wireless device, comprising:
a usage analysis engine capable of receiving data on the environment of said wireless device, said data used to create a profile, said usage analysis engine further capable of correlating a present profile with previous profiles; and
wherein said wireless device activates or deactivates some functionality based on the correlation of said present profile with said previous profiles provided by said usage analysis engine.

20. The wireless device of claim 19, wherein said wireless device is selected from the group comprising:
personal digital assistant (PDA);
printer;
personal computer;
server;
mobile phone;
e-wallet;
wireless local area network access point;
wide area network access point; and
personal area network access point.

21. The wireless device of claim 19, wherein said usage analysis engine is further capable of receiving input from a user of said wireless device to direct the correlation algorithm so as to allow customization of when and what functionality said wireless device automatically activates or deactivates based on the correlation of said present profile with said previous profiles provided by said usage analysis engine.

22. A method, comprising:
receiving data on the environment of a mobile device by a usage analysis engine, said usage analysis engine creating a profile on said environment; and
correlating present profiles with previous profiles by said usage analysis engine to predict usage.

23. The method of claim 22, wherein said mobile device takes some action or prohibits some action based on the correlation of said present profile with said previous profiles provided by said usage analysis engine.

24. The method of claim 22, wherein said mobile device takes no action based on lack of correlation of said present profile with said previous profiles provided by said usage analysis engine.

25. The method of claim 22, further comprising receiving position information of said mobile device as part of said profile created by said usage engine.

26. The method of claim 25, wherein said position information is determined by a global positioning system.

27. A mobile device capable of predicting usage based on the dynamic state of an environment of said mobile device, comprising:
a usage analysis engine for receiving data on the environment of said mobile device, said usage analysis engine creating profiles of said environment; and
correlating present profiles with previous profiles by said usage analysis engine to predict usage of said mobile device.

28. The mobile device of claim 27, wherein said mobile device takes some action or prohibits some action based on the correlation of said present profile with said previous profiles provided by said usage analysis engine.

29. The mobile device of claim 27, wherein said usage analysis engine is further capable of receiving input from a user of said mobile device to direct the correlation algorithm so as to allow customization of when said mobile device takes some action or prohibits some action based on said correlation of said present profile with said previous profiles.
